(19) United States
(12) Patent Application Publication
(10) Pub. No.: US 2026/0252823 A1
(43) Pub. Date: Aug. 27, 2026

(54) Two-Way Real-Time Translation Device

(71) Applicant: Trent McKee, Hoover, AL (US)

(72) Inventor: Trent McKee, Hoover, AL (US)

(21) Appl. No.: 19/064,591

(22) Filed: Feb. 26, 2025

(51) Int. Cl. G06F 40/58; G10L 13/02; G10L 15/00; G10L 15/16; G10L 15/30; G10L 21/0216; H04L 9/40

(52) U.S. Cl. CPC G06F 40/58; G10L 13/02; G10L 15/005; G10L 15/16; G10L 15/30; G10L 21/0216; H04L 63/0428; G10L 2021/02166

(57) ABSTRACT

A two-way real-time translation device is disclosed, designed to facilitate seamless, uninterrupted communication between speakers of different languages. The device comprises a multi-microphone array for capturing speech input, a high-fidelity speaker system for outputting translated speech, and a processor configured to execute automatic language detection, speech recognition, and translation processing. Upon detecting an initial greeting spoken by users, the device identifies the respective languages and activates real-time bidirectional translation without requiring manual language selection. Captured speech is processed using neural machine translation models, converting spoken input into text, generating a translated output, and synthesizing the translation into natural-sounding speech. The device employs edge AI processing for pre-processing speech locally before transmission to a cloud-based translation engine, reducing latency and improving translation accuracy.

### BACKGROUND OF THE INVENTION

### Field of Invention

The present invention relates to the field of real-time language translation devices. More specifically, it pertains to a portable, AI-powered two-way translation device that enables seamless, uninterrupted communication between speakers of different languages. The invention leverages automatic language detection and real-time speech translation to facilitate natural conversations without requiring manual language selection or turn-based speaking. The device integrates cloud-based AI translation and continuous software updates to enhance translation accuracy and user experience across various applications, including travel, business, healthcare, and emergency response.

### BRIEF SUMMARY OF THE INVENTION

The present invention relates to a portable, AI-powered two-way real-time translation device that enables seamless communication between individuals speaking different languages. Unlike conventional translation solutions that require manual language selection or turn-based speaking, this device features an automatic language detection system activated when each user says “hello” in their respective language. This intuitive activation simplifies the user experience, allowing for immediate and uninterrupted dialogue. The device operates as a standalone unit with built-in microphones, speakers, and connectivity to a user's smartphone for cloud-based AI translation, ensuring high-quality and continuously improving translations.

Designed for versatility, the device is compact and ergonomic, making it suitable for travel, business, healthcare, emergency response, and other multilingual communication scenarios. It offers an AI-powered subscription model, providing access to advanced translation updates, additional language packs, and ongoing software improvements. By addressing common limitations of existing translation tools—such as one-way communication, reliance on smartphones, and awkward usability—the invention delivers a more natural, private, and efficient solution for bridging language barriers.

### BRIEF DESCRIPTION OF THE FIGURES

FIG. 1: A front view of the translation device in an open position, showing the integrated screen and keypad layout, designed for user interaction and control.

FIG. 2: A rear view of the translation device, illustrating the placement of the camera and other external components, along with the device in a folded position to highlight its compact form factor.

### DETAILED DESCRIPTION

The present invention is a two-way real-time translation device designed to facilitate natural, uninterrupted conversations between individuals speaking different languages. Unlike conventional translation solutions that rely on turn-based communication, manual language selection, or smartphone-dependent applications, this invention introduces an automatic language detection and real-time translation system within a dedicated, portable, and user-friendly device. By prioritizing efficiency, affordability, and simplicity, the device eliminates barriers to multilingual communication while maintaining a sleek, flip-phone-like form factor that ensures ease of use and portability.

The device is designed with a compact, lightweight housing that resembles a classic flip phone, ensuring it is both ergonomic and portable. The outer shell is composed of high-durability materials, resistant to wear and tear, making the device suitable for frequent use in travel, business, and other real-world applications. When opened, the device activates automatically, allowing for immediate access to its translation functionalities. The internal hardware includes a multi-microphone array optimized for voice capture in varying environments, a high-fidelity speaker system for clear and natural audio playback, a dedicated processor for speech processing and pre-translation analysis, and a wireless communication module for connectivity with a cloud-based translation engine.

A key feature of the invention is its intuitive activation system. Unlike traditional translation devices that require manual language selection, the device detects languages automatically. When two users greet each other by saying “hello” in their respective languages, the system identifies the spoken languages through real-time phonetic analysis and linguistic classification. This is achieved using a combination of deep learning-based speech recognition algorithms and an extensive multilingual phoneme database. Once the languages are identified, the device establishes a continuous bidirectional translation channel, enabling both users to speak naturally without pausing for manual input.

The translation process consists of three primary stages. First, the device converts received speech into text using a speech-to-text algorithm. This text is then processed using a neural machine translation engine trained on extensive linguistic datasets, allowing for accurate, context-aware translation. Finally, the translated text is synthesized into speech using a natural-sounding text-to-speech system, which mimics human-like pronunciation and intonation to produce fluid, lifelike audio output. The combination of real-time processing and advanced AI modeling allows conversations to flow naturally, without the delays commonly associated with conventional translation tools.

To ensure high-quality speech capture, the device is equipped with a multi-microphone array that utilizes directional beamforming technology to isolate the primary speaker's voice while filtering out background noise. This allows the device to function effectively even in noisy environments such as crowded streets, airports, or conference halls. Captured speech is pre-processed using onboard speech enhancement algorithms, which include noise suppression, echo cancellation, and automatic gain control to further refine audio input before transmission to the translation engine.

Wireless connectivity is a fundamental component of the device's functionality. The system features a communication module that supports multiple connectivity options, including Bluetooth, Wi-Fi, and cellular networks, allowing it to interface with a smartphone or establish a direct connection to cloud-based translation services. A proprietary smartphone application provides users with additional features, such as access to expanded language packs, personalized translation settings, and the ability to store and review past translations. The app also facilitates over-the-air firmware updates, ensuring continuous improvements in translation accuracy and expanded language support over time.

The device supports three operational modes to maximize versatility. In cloud-connected real-time translation mode, the system transmits speech data to a remote AI server for high-accuracy processing and translation. In offline translation mode, the device relies on preloaded language models stored in its internal memory, allowing for basic translation in situations where internet connectivity is unavailable. In hybrid translation mode, the system dynamically switches between local and cloud processing based on network conditions, ensuring optimal performance while conserving bandwidth and processing power.

A machine learning model is exposed to datasets containing original language inputs and translated language outputs which are known to be accurate. The model is trained to recognize accurate translations based on the dataset. The training phase ensures the model's predictive accuracy.

After training, the machine learning categorization engine processes the original language data using pre-trained models trained on these datasets. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said original language data using machine learning algorithms trained on historical datasets regarding accurate translation, wherein the AI/ML categorization engine makes a prediction regarding an appropriate translation in the desired language.

A rechargeable lithium-polymer battery powers the device, designed for extended use with intelligent power management features. To optimize energy consumption, the device incorporates an adaptive wake-on-voice function, which activates processing components only when speech is detected. Fast-charging capabilities allow the device to regain substantial battery life with minimal downtime, supporting both USB-C and wireless charging standards for added convenience.

Security and privacy considerations are integral to the device's design. All voice transmissions are encrypted using end-to-end encryption protocols, ensuring that user conversations remain private and protected against unauthorized access. The cloud-based translation services operate within secure, encrypted environments, and all user data is anonymized to prevent tracking or misuse. For enterprise users, the system can be configured to comply with international data protection regulations, including GDPR and HIPAA, providing an added layer of security for business and medical applications.

The invention is designed to serve a broad range of users, including travelers, business professionals, medical personnel, and emergency responders. For travelers, it provides a practical solution for navigating multilingual environments without relying on smartphones or requiring cumbersome setup procedures. In corporate settings, the device enables professionals to engage in cross-border negotiations with high-accuracy translation that supports specialized business terminology. In medical and emergency response scenarios, where immediate communication is critical, the device facilitates seamless interaction between healthcare providers and patients, reducing language barriers that could otherwise impact treatment and decision-making.

A flexible business model supports the commercialization of the device, combining direct hardware sales with a subscription-based service. While core translation functionalities are embedded within the device, premium features such as expanded language packs, industry-specific terminology databases, and AI-driven translation enhancements are available through a tiered subscription plan. Enterprise licensing options are also available for businesses and government organizations requiring specialized translation solutions tailored to their operational needs.

This invention represents a major advancement in real-time translation technology by integrating AI-driven speech recognition, machine learning-based natural language processing, and cloud-enhanced machine translation within a compact and intuitive device. By eliminating the need for manual language selection, reducing latency through intelligent processing, and ensuring continuous improvements through AI updates, the device redefines multilingual communication and provides users with a seamless, highly accurate, and efficient translation experience.

### DETAILED DESCRIPTION OF FIGURES

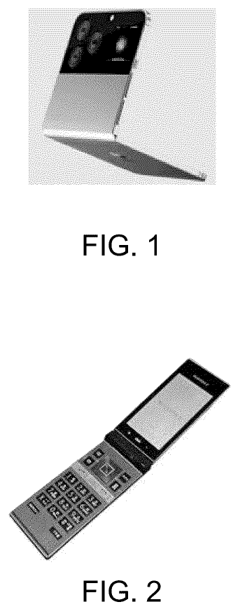

FIG. 1 illustrates a front view of the translation device in its open configuration, revealing the screen and keypad layout. The screen is positioned on the upper half of the device, designed to display real-time translations, system notifications, and user settings. The lower half of the device houses a physical or touch-sensitive keypad, which may include essential control buttons for adjusting settings, initiating translations, or managing device functions. The hinge mechanism connecting the two halves allows for smooth opening and closing, ensuring ease of use and durability. The form factor is designed to be compact and ergonomic, making the device portable and suitable for handheld operation.

FIG. 2 provides a rear view of the translation device, showing its external casing and the integrated camera system. The casing is designed for durability, incorporating high-quality materials resistant to wear and damage from frequent use. The camera, positioned on the back panel, may be included for future functionalities such as visual text translation or augmented reality-based translation features. This figure also depicts the device in its folded state, highlighting its compact form when closed. The folding mechanism enhances portability, allowing users to easily store the device in a pocket or bag when not in use. The seamless design ensures that all essential components, including microphones, speakers, and wireless communication modules, remain protected while maintaining accessibility for efficient real-time translation.

What is claimed is:

1. A two-way real-time translation device comprising:
a. a housing configured to be portable and ergonomically designed for handheld or wearable use;
b. a multi-microphone array configured to capture speech input from multiple users while employing noise cancellation and beamforming techniques to isolate primary speech signals;
c. a speaker system configured to output translated speech with high-fidelity audio reproduction;
d. a processor operably connected to the microphone array and speaker system, the processor configured to execute speech recognition, language detection, and pre-processing functions;
e. a wireless communication module configured to establish connectivity with a cloud-based translation engine via a user's smartphone or a direct network connection;
f. an automatic language detection system that, upon detecting an initial greeting spoken by users, identifies the respective languages and activates real-time bidirectional translation without requiring manual language selection;
g. a translation processing system configured to:
i. convert received speech input into text using a speech-to-text conversion algorithm;
ii. process the converted text using an application-specific integrated circuit (ASIC) for an artificial neural network connected to the processor, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said original language data using machine learning algorithms trained on historical datasets regarding accurate translation, wherein the AI/ML categorization engine makes a prediction regarding an appropriate translation in the desired language to generate a translated output;
iii. synthesize the translated output into natural-sounding speech using a text-to-speech synthesis engine; and
iv. transmit the synthesized speech output to the speaker system for real-time audio playback; and
h. a power management system comprising a rechargeable battery and an adaptive power consumption module designed to optimize energy efficiency during use.

2. The translation device of claim 1, wherein the automatic language detection system utilizes a phonetic and linguistic analysis module to classify and differentiate spoken languages based on a predefined multilingual phoneme database.

3. The translation device of claim 1, wherein the device employs edge AI processing to locally pre-process speech input prior to cloud transmission, thereby reducing latency and improving translation speed.

4. The translation device of claim 1, wherein the multi-microphone array is configured to utilize directional beamforming to focus on the primary speaker while filtering out background noise and secondary voices.

5. The translation device of claim 1, wherein the wireless communication module is configured to support multiple connectivity options, including Bluetooth, Wi-Fi, and cellular networks, to facilitate seamless integration with a smartphone or direct cloud-based services.

6. The translation device of claim 1, further comprising an over-the-air update system configured to periodically download and install software updates, including improvements to speech recognition, translation accuracy, and expanded language support.

7. The translation device of claim 1, wherein the translation processing system is configured to operate in multiple modes, including:
a. a cloud-connected real-time translation mode, wherein speech data is transmitted to a remote AI server for processing and translation;
b. an offline translation mode, wherein the device utilizes preloaded language models stored in its internal memory to perform local translation; and
c. a hybrid translation mode, wherein the device dynamically switches between local and cloud processing based on network conditions.

8. The translation device of claim 1, further comprising a user interface system accessible via a smartphone application, the application configured to allow users to manage translation preferences, select additional language packs, and monitor subscription-based service plans.

9. The translation device of claim 1, wherein the processor is further configured to utilize artificial intelligence-based speech enhancement techniques, including echo cancellation, adaptive noise suppression, and automatic gain control, to improve speech clarity and recognition accuracy.

10. The translation device of claim 1, wherein the text-to-speech synthesis engine employs a neural deep-learning model trained on natural human speech data to generate output with realistic intonation and cadence.

11. The translation device of claim 1, wherein the security module implements end-to-end encryption for all transmitted speech data, ensuring privacy and protection against unauthorized interception.

12. The translation device of claim 1, wherein the power management system further comprises:
a. a smart wake-on-voice function that activates processing components only when speech input is detected; and
b. a fast-charging module supporting USB-C and wireless charging standards for rapid battery replenishment.

13. The translation device of claim 1, wherein the device is configured to provide real-time multilingual translation for applications in travel, business, medical, and emergency response scenarios, enabling seamless communication across diverse industries.

14. The translation device of claim 1, wherein the translation processing system is further configured to integrate industry-specific language databases for domain-specific translation, including medical terminology, legal phrases, and technical jargon.

15. The translation device of claim 1, wherein the automatic language detection system supports dynamic language switching, allowing users to transition between multiple languages within a single conversation without requiring manual adjustments.
